(19) United States
(12) Patent Application Publication
(10) Pub. No.: US 2011/0201278 A1
(43) Pub. Date: Aug. 18, 2011

(54) WIRELESS TERMINAL DEVICE AND COMMUNICATION QUALITY DISPLAY METHOD

(75) Inventor: Yoshihiko Takei, Kanagawa (JP)

(73) Assignee: PANASONIC CORPORATION, Osaka (JP)

(21) Appl. No.: 13/123,881

(22) PCT Filed: Jul. 24, 2009
(86) PCT No.: PCT/JP2009/003504

§ 371 Date: Apr. 12, 2011

(30) Foreign Application Priority Data
Oct. 14, 2008 (JP) 2008-265320

(51) Int. Cl. H04W 24/08

(52) U.S. Cl. 455/67.7

(57) ABSTRACT

Disclosed is a wireless terminal device that can display the communication quality according to the service content with reception of service provided using multiple different communication formats. In the device, a first reception field strength detector (101) detects the reception field strength with communication in a first communication format. A second reception field strength detector (102) detects the reception field strength with communication in a second communication format. A wireless status coordination unit (103) determines the reception field strength with reception of service provided with communication in the first communication format and the second communication format on the basis of the various reception field strengths detected by the first reception field strength detector (101) and the second reception field strength detector (102). A display (105) displays the reception field strength determined by the wireless status coordination unit (103).

### TECHNICAL FIELD

The present invention relates to a radio terminal apparatus and communication quality display method, and more particularly to a radio terminal apparatus and communication quality display method that receive service provision using a plurality of different communication methods.

### BACKGROUND ART

In recent years, a portable terminal has been known that can receive provision of a desired service by using a plurality of different communication methods simultaneously. For example, a service whereby program content is received by broadcasting and participation in a vote or chat related to that program content is implemented by means of communication, or a service whereby viewing rights for that program content are obtained by means of communication, can be conceived of as services in which broadcasting and communication are linked.

With a service of this kind, if provision of the service is limited to a user who is viewing content, or if it is necessary to periodically confirm viewing rights for viewed content, service provision cannot be received if a signal cannot be received with predetermined quality in all the different communication methods.

Therefore, conventionally, a user confirms the radio status of the plurality of different communication methods individually, and determines whether or not service use is possible based on the confirmed individual radio statuses. In this case, even if the radio status of one or some of the communication methods is good, a state in which service is suddenly unable to be received will arise if the radio status of another communication method is poor. Also, if, in addition to the above-described service, a user is also able to use a service provided by means of communication using a single communication method, the user must determine whether or not a service whose provision is to be received henceforth is a service for which the radio statuses of a plurality of communication methods must be confirmed.

The methods disclosed in Patent Literature 1 and Patent Literature 2 are known as methods of solving such problems. In Patent Literature 1, two or more graphics are created that correspond to the respective conditions of each of two or more mobile communication networks, the two or more created graphics are combined, and a graphic obtained as a result of this combining is incorporated in an image for posting as a specific graphic according to the standby state of a communication terminal apparatus. In Patent Literature 1, a specific graphic has a form in which graphics corresponding to the conditions of each mobile communication network mutually overlap in such a way that parts whose forms are equal coincide. Also, in a specific graphic, overlapping parts are displayed in a color that combines colors specific to each mobile communication network.

In Patent Literature 2, for each received signal detected by a PHS reception circuit and a PDC reception circuit respectively, a color corresponding to the field strength of the received signal is read from a data table stored in memory beforehand, and a combination color is created by combining those read colors, and is displayed. In Patent Literature 2, when a displayed combination color comprises only a green component, this means that PDC communication is out of service (that is, out of range), when a displayed combination color comprises only a red component, this means that PHS communication is out of service, and when a displayed combination color is black, this means that both PHS communication and PDC communication are out of service.

### CITATION LIST

### Patent Literature

### PTL 1

### Japanese Patent Application Laid-Open No. 2002-10351

### PTL 2

### Japanese Patent Application Laid-Open No. 2002-353826

### SUMMARY OF INVENTION

### Technical Problem

However, in Patent Literature 1 and Patent Literature 2, there is an either-or choice between communication methods used, and therefore a displayed combination color is simply the result of combining colors corresponding to the reception field strengths of the communication methods, and does no more than indicate the reception field strength of each communication method. Therefore, a problem with Patent Literature 1 and Patent Literature 2 is that it is only possible to confirm usable communication methods individually, and therefore communication quality corresponding to service contents cannot be displayed when provision of a desired service is received using different communication methods simultaneously.

It is therefore an object of the present invention to provide a radio terminal apparatus and communication quality display method that can display communication quality corresponding to service contents when service provision is received using a plurality of different communication methods.

### Solution to Problem

A radio terminal apparatus of the present invention employs a configuration having: a detection section that, when service provision is received by performing communication by means of a plurality of different communication methods, detects communication quality individually when communication is performed by each communication method; a determination section that determines communication quality when the service provision is received, based on each detected communication quality; and a display section that displays the determined communication quality.

A communication quality display method of the present invention is a communication quality display method in a radio terminal apparatus that receives service provision by performing communication by means of a plurality of different communication methods, and has the steps of: detecting communication quality individually when communication is performed by each communication method; determining communication quality when the service provision is received, based on each detected communication quality; and displaying the determined communication quality.

### Advantageous Effects of Invention

The present invention can display communication quality corresponding to service contents when service provision is received using a plurality of different communication methods.

### BRIEF DESCRIPTION OF DRAWINGS

FIG. 1 is a block diagram showing the configuration of a radio terminal apparatus according to Embodiment 1 of the present invention;

FIG. 2 is a flowchart showing the operation of a radio terminal apparatus according to Embodiment 1 of the present invention;

FIG. 3 is a drawing showing the relationship between the position of a radio terminal apparatus and various communication areas according to Embodiment 1 of the present invention;

FIG. 4 is a drawing showing reception field strength detection results of a first reception field strength detection section and second reception field strength detection section, an adjustment result of a radio status adjustment section, and display on a display section, at various positions of a radio terminal apparatus according to Embodiment 1 of the present invention;

FIG. 5 is a drawing showing an example of detection results of a first reception field strength detection section and detection results of a second reception field strength detection section at various positions according to Embodiment 1 of the present invention;

FIG. 6 is a block diagram showing the configuration of a radio terminal apparatus according to Embodiment 2 of the present invention;

FIG. 7 is a drawing showing an out of service determination table according to Embodiment 2 of the present invention;

FIG. 8 is a drawing showing an adjustment value calculation table according to Embodiment 2 of the present invention;

FIG. 9 is a flowchart showing the operation of a radio terminal apparatus according to Embodiment 2 of the present invention;

FIG. 10 is a block diagram showing the configuration of a radio terminal apparatus according to Embodiment 3 of the present invention;

FIG. 11 is a block diagram showing the configuration of a radio terminal apparatus according to Embodiment 4 of the present invention; and

FIG. 12 is a block diagram showing the configuration of a radio terminal apparatus according to Embodiment 5 of the present invention.

### DESCRIPTION OF EMBODIMENTS

Now, embodiments of the present invention will be described in detail with reference to the accompanying drawings.

### Embodiment 1

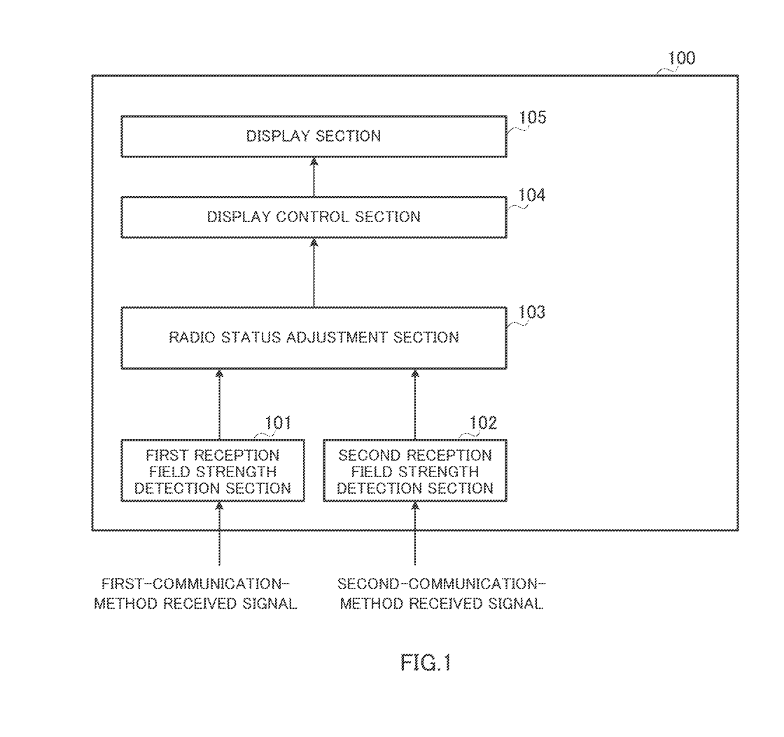

FIG. 1 is a block diagram showing the configuration of radio terminal apparatus 100 according to Embodiment 1 of the present invention.

First reception field strength detection section 101 has a first-communication-method received signal received by an antenna (not shown) as input, and detects the reception field strength (RSSI: Received Signal Strength Indicator) of the input first-communication-method received signal. Then first reception field strength detection section 101 outputs the detected reception field strength to radio status adjustment section 103 as a detection result, or outputs a number of antenna bars corresponding to the detected reception field strength to radio status adjustment section 103 as a detection result. Here, the first communication method is, for example, a cellular method, PHS (Personal Handy-phone System) method, Bluetooth, wireless LAN, WiMAX (Worldwide Interoperability for Microwave Access), digital broadcasting, or the like.

Second reception field strength detection section 102 has a second-communication-method received signal received by an antenna (not shown) as input, and detects the reception field strength of the input second-communication-method received signal. Then second reception field strength detection section 102 outputs the detected reception field strength to radio status adjustment section 103 as a detection result, or outputs a number of antenna bars corresponding to the detected reception field strength to radio status adjustment section 103 as a detection result. Here, the second communication method is, for example, a cellular method, PHS method, Bluetooth, wireless LAN, WiMAX, digital broadcasting, or the like. However, the second communication method is different from the first communication method, with, for example, a wireless LAN being used as the first communication method and a cellular method being used as the second communication method.

Based on the reception field strength detection result input from first reception field strength detection section 101 and the reception field strength detection result input from second reception field strength detection section 102, radio status adjustment section 103 determines the reception field strength when service is received using both the first communication method and the second communication method. At this time, radio status adjustment section 103 determines the number of bars in an antenna bar display on display section 105 as the reception field strength. Then radio status adjustment section 103 outputs the determined reception field strength to display control section 104. Provision may also be made for radio status adjustment section 103 to output the reception field strength determined this time to display control section 104 only if the reception field strength determined this time is different from the reception field strength determined the previous time. The reception field strength determination method used by radio status adjustment section 103 will be described later herein.

Display control section 104 performs display processing for displaying the reception field strength input from radio status adjustment section 103, and performs control to display the reception field strength on display section 105.

Display section 105 is, for example, a liquid crystal display (LCD), and displays the reception field strength under the control of display control section 104.

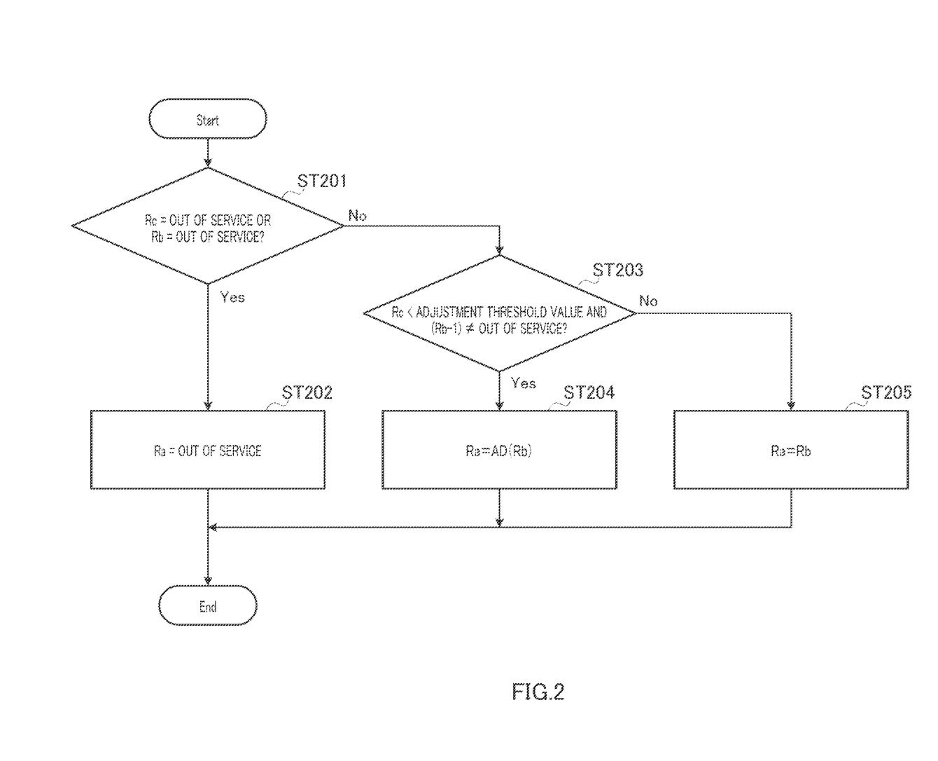

Next, the operation of radio terminal apparatus 100 will be described using FIG. 2. FIG. 2 is a flowchart showing the operation of radio terminal apparatus 100. In FIG. 2, a case is shown by way of example in which first reception field strength detection section 101 and second reception field strength detection section 102 output a number of antenna bars corresponding to a detected reception field strength to radio status adjustment section 103 as a reception field strength detection result.

Radio status adjustment section 103 determines whether or not reception field strength detection result Rb input from first reception field strength detection section 101, or reception field strength detection result Rc input from second reception field strength detection section 102, is at an out of service level (Rc=out of service or Rb=out of service?) (step ST 201).

If reception field strength detection result Rb input from first reception field strength detection section 101 or reception field strength detection result Rc input from second reception field strength detection section 102 is at an out of service level (step ST 201: Yes), radio status adjustment section 103 determines that reception field strength when service is received is to be displayed as out of service (Ra=out of service) (step ST 202). In FIG. 2, Ra is the reception field strength output from radio status adjustment section 103.

On the other hand, if reception field strength detection result Rb input from first reception field strength detection section 101 or reception field strength detection result Rc input from second reception field strength detection section 102 is not at an out of service level (step ST 201: No), radio status adjustment section 103 determines whether or not the reception field strength detection result input from second reception field strength detection section 102 is smaller than an adjustment threshold value (Rc<adjustment threshold value?). Furthermore, radio status adjustment section 103 determines whether or not, when 1 is subtracted from the reception field strength detection result input from first reception field strength detection section 101 (Rb−1), the subtraction result is not 0 ((Rb−1)≠out of service?) (step ST 203). This determination means determining whether or not the adjusted result is not out of service.

If the reception field strength detection result input from second reception field strength detection section 102 is smaller than the adjustment threshold value, and when 1 is subtracted from the reception field strength detection result input from first reception field strength detection section 101 the subtraction result is not 0 (step ST 203: Yes), radio status adjustment section 103 makes the first reception field strength detection section 101 reception field strength detection result smaller by a predetermined amount (Ra=AD(Rb)) (step ST 204). That is to say, radio status adjustment section 103 lowers the first reception field strength detection section 101 reception field strength detection result by 1 level. In FIG. 2, AD(Rb) is an adjustment function for adjusting a reception field strength detection result, and in this embodiment is a function that lowers a reception field strength detection result by 1 level.

On the other hand, if the reception field strength detection result input from second reception field strength detection section 102 is not smaller than the adjustment threshold value, or if the subtraction result is 0 when 1 is subtracted from the reception field strength detection result input from first reception field strength detection section 101 (step ST 203: No), radio status adjustment section 103 does not perform adjustment of the first reception field strength detection section 101 reception field strength detection result (Ra=Rb) (step ST 205). That is to say, radio status adjustment section 103 outputs the first reception field strength detection section 101 reception field strength detection result as is.

In FIG. 2, if a volume of data transmitted using the first communication method is greater than a volume of data transmitted using the second communication method, the first reception field strength of the first communication method can be adjusted using the second reception field strength of the second communication method. Therefore, in this case, a reception field strength adjusted on the basis of the first reception field strength of the first communication method with the largest data capacity can be displayed as the reception field strength when service provision is received.

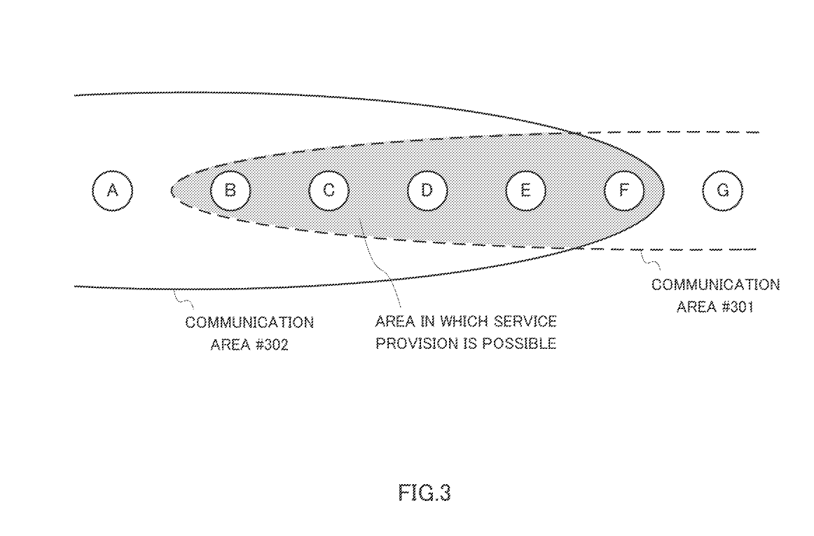

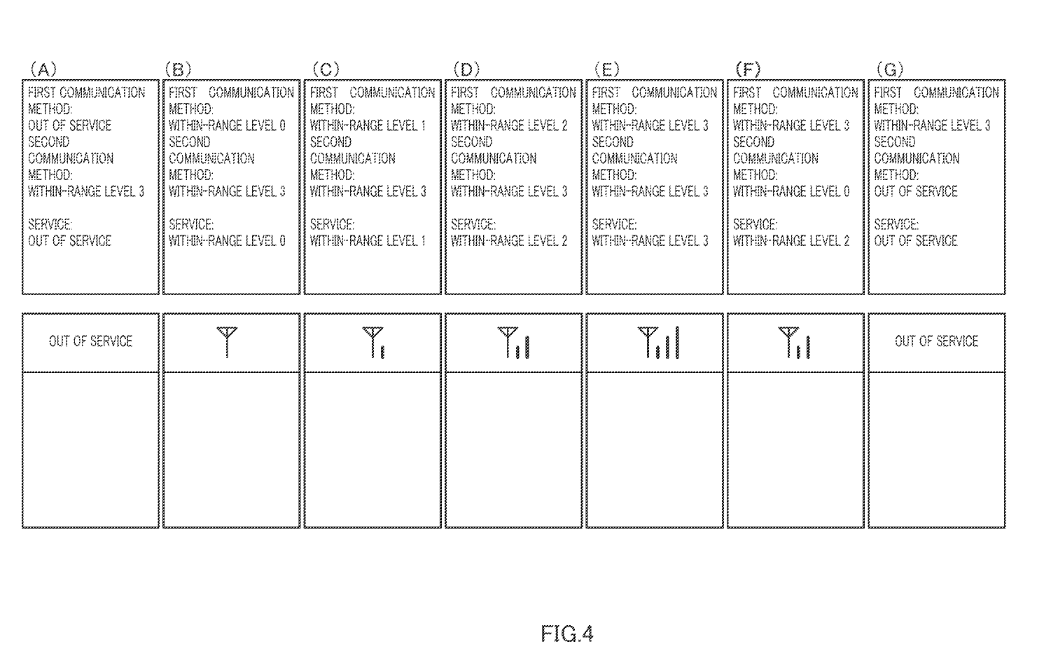

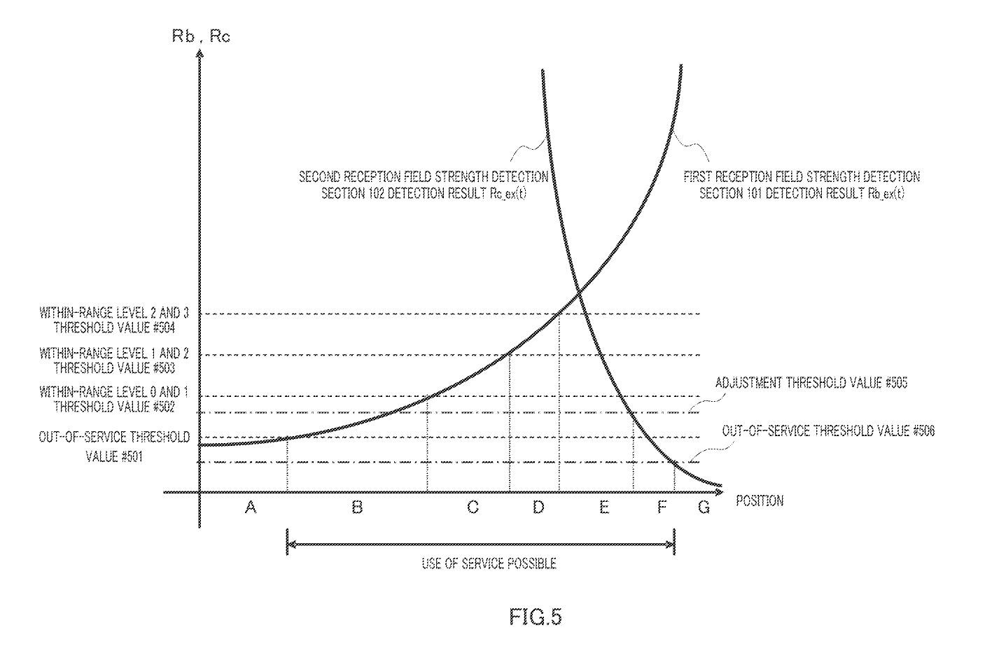

FIG. 3 is a drawing showing the relationship between the position of radio terminal apparatus 100 and various communication areas; FIG. 4 is a drawing showing reception field strength detection results of first reception field strength detection section 101 and second reception field strength detection section 102, an adjustment result of radio status adjustment section 103, and display on display section 105, at positions A through G in FIG. 3; and FIG. 5 is a drawing showing an example of first reception field strength detection section 101 detection results and second reception field strength detection section 102 detection results at positions A through G in FIG. 3.

In FIG. 3, position A is within second-communication-method communication area #302, but outside first-communication-method communication area #301. Also, position G is outside second-communication-method communication area #302, but within first-communication-method communication area #301. Furthermore, positions B through F are within both first-communication-method communication area #301 and second-communication-method communication area #302. Consequently, positions B through F are in an area in which service use is possible. In FIG. 4, antenna bars are displayed by means of graphics (FIG. 4(C) through FIG. 4(F)) combining an antenna and bars. The number of bars changes according to the reception field strength.

As shown in FIG. 5, when radio terminal apparatus 100 performs communication at position A, first reception field strength detection section 101 detection result Rb_ex(t) is smaller than out-of-service threshold value #501. Therefore, as shown in FIG. 4(A), first reception field strength detection section 101 detects “out of service” as a reception field strength detection result, and second reception field strength detection section 102 detects level 3 as a reception field strength detection result. As a result, radio status adjustment section 103 determines that the reception field strength when service is received is to be made “out of service”, and display section 105 provides an “out of service” display.

Also, as shown in FIG. 5, when radio terminal apparatus 100 performs communication at position B, first reception field strength detection section 101 detection result Rb_ex(t) is smaller than within-range level 0 and 1 threshold value #502 and greater than or equal to out-of-service threshold value #501. Therefore, as shown in FIG. 4(B), first reception field strength detection section 101 detects level 0 as a reception field strength detection result, and second reception field strength detection section 102 detects level 3 as a reception field strength detection result. As a result, radio status adjustment section 103 determines that the reception field strength when service is received is to be made level 0, and display section 105 provides an antenna bar display indicating level 0.

Also, as shown in FIG. 5, when radio terminal apparatus 100 performs communication at position C, first reception field strength detection section 101 detection result Rb_ex(t) is smaller than within-range level 1 and 2 threshold value #503 and greater than or equal to within-range level 0 and 1 threshold value #502. Therefore, as shown in FIG. 4(C), first reception field strength detection section 101 detects level 1 as a reception field strength detection result, and second reception field strength detection section 102 detects level 3 as a reception field strength detection result. As a result, radio status adjustment section 103 determines that the reception field strength when service is received is to be made level 1, and display section 105 provides an antenna bar display indicating level 1.

Also, as shown in FIG. 5, when radio terminal apparatus 100 performs communication at position D, first reception field strength detection section 101 detection result Rb_ex(t) is smaller than within-range level 2 and 3 threshold value #504 and greater than or equal to within-range level 1 and 2 threshold value #503. Therefore, as shown in FIG. 4(D), first reception field strength detection section 101 detects level 2 as a reception field strength detection result, and second reception field strength detection section 102 detects level 3 as a reception field strength detection result. As a result, radio status adjustment section 103 determines that the reception field strength when service is received is to be made level 2, and display section 105 provides an antenna bar display indicating level 2.

Also, as shown in FIG. 5, when radio terminal apparatus 100 performs communication at position E, first reception field strength detection section 101 detection result Rb_ex(t) is greater than or equal to within-range level 2 and 3 threshold value #504, and second reception field strength detection section 102 detection result Rc_ex(t) is greater than or equal to adjustment threshold value #505. Therefore, as shown in FIG. 4(E), first reception field strength detection section 101 detects level 3 as a reception field strength detection result, and second reception field strength detection section 102 detects level 3 as a reception field strength detection result. As a result, radio status adjustment section 103 determines that the reception field strength when service is received is to be made level 3, and display section 105 provides an antenna bar display indicating level 3.

Also, as shown in FIG. 5, when radio terminal apparatus 100 performs communication at position F, first reception field strength detection section 101 detection result Rb_ex(t) is greater than or equal to within-range level 2 and 3 threshold value #504, and second reception field strength detection section 102 detection result Rc_ex(t) is smaller than adjustment threshold value #505 and greater than out-of-service threshold value #506. Therefore, as shown in FIG. 4(F), first reception field strength detection section 101 detects level 3 as a reception field strength detection result, and second reception field strength detection section 102 detects level 0 as a reception field strength detection result. As a result, radio status adjustment section 103 subtracts 1 from first reception field strength detection section 101 detection result Rb_ex(t)=3 (Ra=AD(Rb)=Rb−1), and determines that the reception field strength when service is received is to be made level 2, and display section 105 provides an antenna bar display indicating level 2.

Also, as shown in FIG. 5, when radio terminal apparatus 100 performs communication at position G, first reception field strength detection section 101 detection result Rb_ex(t) is greater than or equal to within-range level 2 and 3 threshold value #504, and second reception field strength detection section 102 detection result Rc_ex(t) is less than or equal to out-of-service threshold value #506. Therefore, as shown in FIG. 4(G), first reception field strength detection section 101 detects level 3 as a reception field strength detection result, and second reception field strength detection section 102 detects “out of service” as a reception field strength detection result. As a result, radio status adjustment section 103 determines that the reception field strength when service is received is to be made “out of service”, and display section 105 provides an “out of service” display.

From the above, it can be seen that when radio terminal apparatus 100 moves from position F to position G, display section 105 displays a reception field strength lower than an actual first reception field strength detection section 101 reception field strength detection result. As a result, a user can confirm that there is a possibility of service ceasing to be receivable by viewing the display on display section 105.

In contrast, conventionally, an actual reception field strength detection result for a first communication method is displayed as is. For example, when a radio terminal apparatus is at position F, a level 3 antenna bar display is provided. Therefore, conventionally, when a radio terminal apparatus moves from position F to position G, an out of service state suddenly arises even though level 3 is being displayed, and service suddenly ceases to be receivable when not expected by the user.

A description will now be given of the operation of radio terminal apparatus 100 when first reception field strength detection section 101 and second reception field strength detection section 102 output an actual detected reception field strength to radio status adjustment section 103 as a detection result.

In this case, radio status adjustment section 103 indirectly adjusts the number of bars in an antenna bar display on display section 105 by finding a weighted average. That is to say, radio status adjustment section 103 finds a weighted average by means of equation 1.

AD(RB,Rc)=((Wb*Rb+Wc*Rc)/(Rb+Rc)) (Equation 1)

where:

AD(RB, Rc): weighted average

Wb, Wc: weighting coefficients

Rb: First reception field strength detection section 101 detection result (RSSI)

Rc: Second reception field strength detection section 102 detection result (RSSI)

Then radio status adjustment section 103 adjusts the number of bars in the antenna bar display by comparing the weighted average found by means of above equation 1 with a threshold value. For example, if the weighted average is less than or equal to the threshold value, radio status adjustment section 103 determines that the number of bars in the antenna bar display determined using a reception field strength detected by first reception field strength detection section 101 is to be decreased by 1. Other operations of radio terminal apparatus 100 are as shown in FIG. 2 through FIG. 5, and therefore a description thereof is omitted here.

Thus, according to this embodiment, reception field strength corresponding to service contents can be displayed when service provision is received using a plurality of communication methods. Also, according to this embodiment, by adjusting reception field strength according to individual transmission capacities in a plurality of communication methods, reception field strength adjusted on the basis of a communication method for which good quality is required, such as a communication method in which a large volume of data is transmitted, can be displayed as the reception field strength when service provision is received.

### Embodiment 2

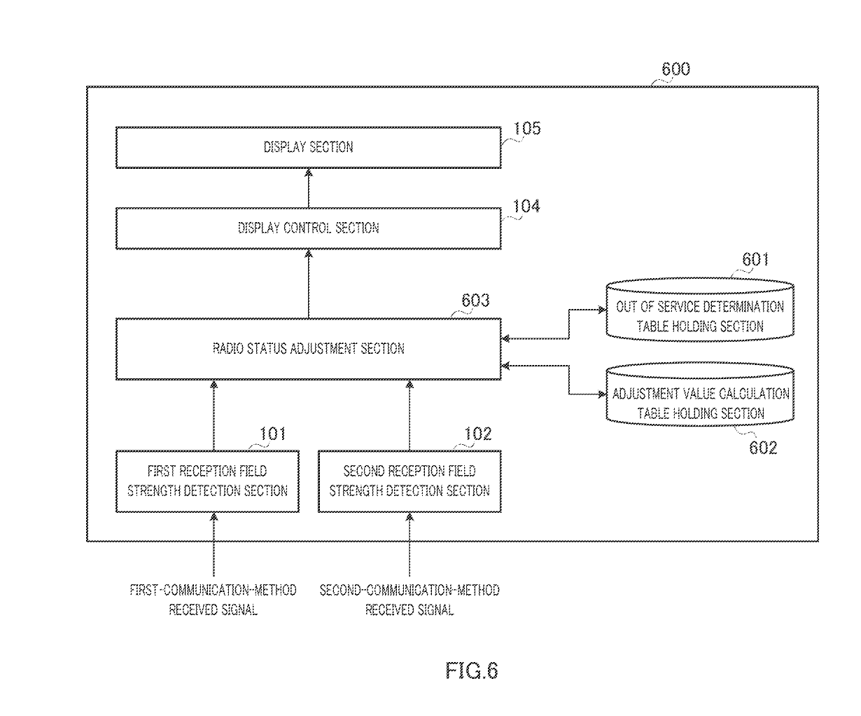

FIG. 6 is a block diagram showing the configuration of radio terminal apparatus 600 according to Embodiment 2 of the present invention.

As compared with radio terminal apparatus 100 according to Embodiment 1 shown in FIG. 1, radio terminal apparatus 600 shown in FIG. 6 is additionally provided with out of service determination table holding section 601 and adjustment value calculation table holding section 602, and has radio status adjustment section 603 instead of radio status adjustment section 103. Configuration parts in FIG. 6 identical to those in FIG. 1 are assigned the same reference codes as in FIG. 1, and descriptions thereof are omitted here.

Out of service determination table holding section 601 holds threshold values for determining whether or not a detected reception field strength is at an out of service level.

Adjustment value calculation table holding section 602 holds threshold values for determining a reception field strength when service is received using both a first communication method and a second communication method.

First reception field strength detection section 101 has a first-communication-method received signal received by an antenna (not shown) as input, and detects the reception field strength of the input first-communication-method received signal. Then first reception field strength detection section 101 outputs the detected reception field strength to radio status adjustment section 603 as a detection result, or outputs a number of antenna bars corresponding to the detected reception field strength to radio status adjustment section 603 as a detection result.

Second reception field strength detection section 102 has a second-communication-method received signal received by an antenna (not shown) as input, and detects the reception field strength of the input second-communication-method received signal. Then second reception field strength detection section 102 outputs the detected reception field strength to radio status adjustment section 603 as a detection result, or outputs a number of antenna bars corresponding to the detected reception field strength to radio status adjustment section 603 as a detection result.

Radio status adjustment section 603 determines the reception field strength when service is received using both the first communication method and the second communication method by comparing the reception field strength detection result input from first reception field strength detection section 101 and the reception field strength detection result input from second reception field strength detection section 102 with an out of service threshold value held in out of service determination table holding section 601 and an adjustment value held in adjustment value calculation table holding section 602. At this time, radio status adjustment section 603 determines the number of bars in an antenna bar display on display section 105 as the reception field strength. Then radio status adjustment section 603 outputs the determined reception field strength to display control section 104. Provision may also be made for radio status adjustment section 603 to output the reception field strength determined this time to display control section 104 only if the reception field strength determined this time is different from the reception field strength determined the previous time. The reception field strength determination method used by radio status adjustment section 603 will be described later herein.

Display control section 104 performs display processing for displaying the reception field strength input from radio status adjustment section 603, and performs control to display the reception field strength on display section 105.

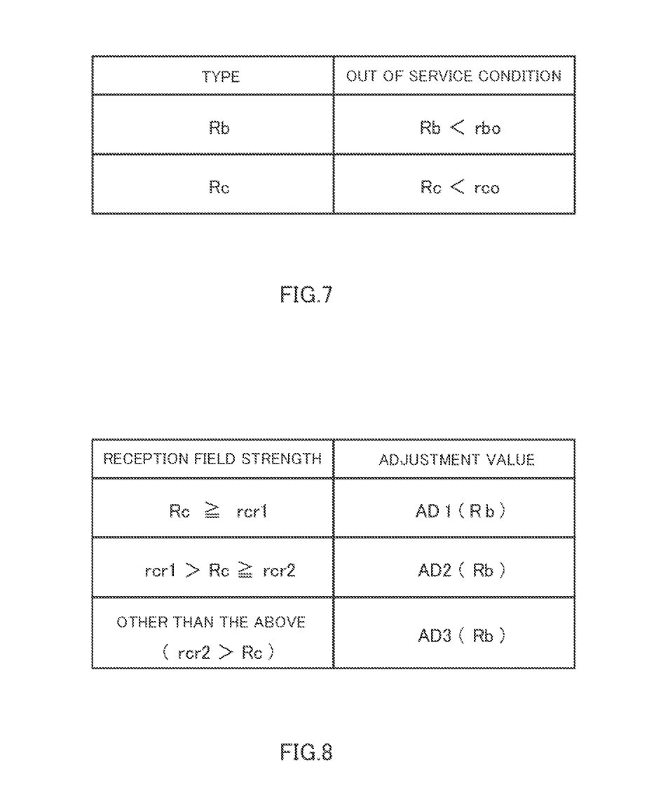

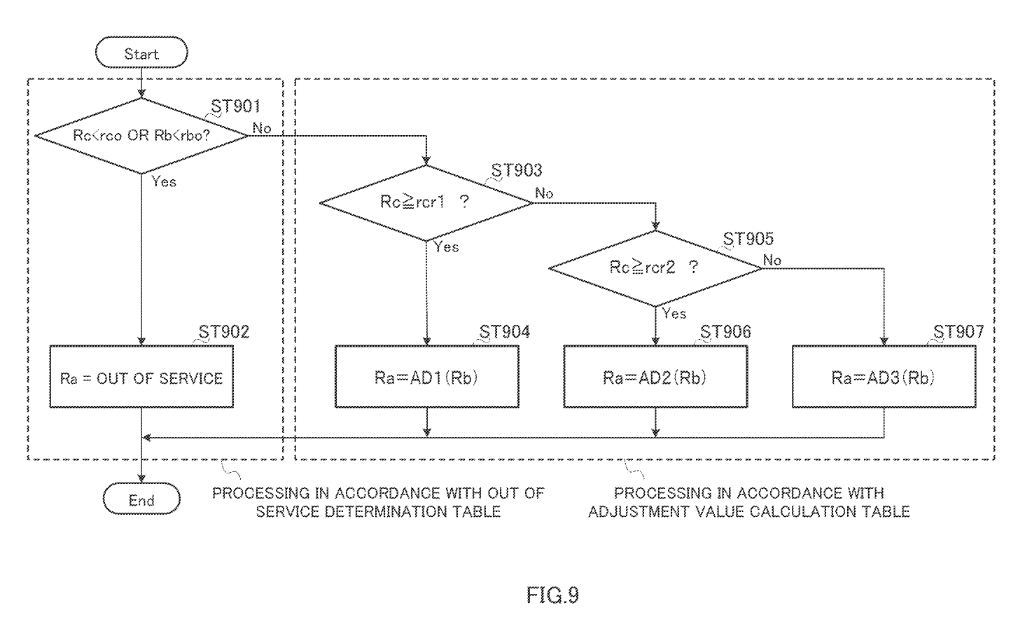

FIG. 7 is a drawing showing an out of service determination table, and FIG. 8 is a drawing showing an adjustment value calculation table. In FIG. 8, rcr1>rcr2 and AD1(Rb)>AD2(Rb)>AD3(Rb).

Next, the operation of radio terminal apparatus 600 will be described using FIG. 9. FIG. 9 is a flowchart showing the operation of radio terminal apparatus 600. In FIG. 9, a case is shown by way of example in which first reception field strength detection section 101 and second reception field strength detection section 102 output a detected reception field strength to radio status adjustment section 603 as a detection result.

Radio status adjustment section 603 determines whether or not reception field strength detection result Rb input from first reception field strength detection section 101, or reception field strength detection result Rc input from second reception field strength detection section 102, is smaller than out of service determination table threshold value rbo or rco respectively (Rc<rco or Rb<rbo?) (step ST901).

If reception field strength detection result Rb input from first reception field strength detection section 101 or reception field strength detection result Rc input from second reception field strength detection section 102 is smaller than out of service determination table threshold value rbo or rco respectively (step ST901: Yes), radio status adjustment section 603 determines that reception field strength when service is received is to be displayed as out of service (Ra=out of service) (step ST902). Then display section 105 provides an “out of service” display.

On the other hand, if reception field strength detection result Rb input from first reception field strength detection section 101 or reception field strength detection result Rc input from second reception field strength detection section 102 is not smaller than out of service determination table threshold value rbo or rco respectively (step ST901: No), radio status adjustment section 603 determines whether or not reception field strength detection result Rc input from second reception field strength detection section 102 is greater than or equal to adjustment value calculation table threshold value rcr1 (Rc≧rcr1?) (step ST903).

If reception field strength detection result Rc input from second reception field strength detection section 102 is greater than or equal to adjustment value calculation table threshold value rcr1 (step ST903: Yes), radio status adjustment section 603 refers to the adjustment value calculation table held in adjustment value calculation table holding section 602, and selects adjustment value AD1(Rb) as adjustment result Ra (Ra=AD1(Rb)) (step ST904). Also, radio status adjustment section 603 adjusts the reception field strength to be output by means of selected adjustment value AD1(Rb). For example, radio status adjustment section 603 multiplies reception field strength detection result Rb input from first reception field strength detection section 101 by “adjustment value AD1(Rb)=1”, finds adjustment result Ra by comparing the multiplication result with a threshold value, and outputs found adjustment result Ra. Then display section 105 displays adjustment result Ra.

On the other hand, if reception field strength detection result Rc input from second reception field strength detection section 102 is not greater than or equal to adjustment value calculation table threshold value rcr1 (step ST903: No), radio status adjustment section 603 determines whether or not reception field strength detection result Rc input from second reception field strength detection section 102 is greater than or equal to adjustment value calculation table threshold value rcr2 (Rc≧rcr2?) (step ST905).

If reception field strength detection result Rc input from second reception field strength detection section 102 is greater than or equal to adjustment value calculation table threshold value rcr2 (step ST905: Yes), radio status adjustment section 603 refers to the adjustment value calculation table held in adjustment value calculation table holding section 602, and selects adjustment value AD2(Rb) as adjustment result Ra (Ra=AD2(Rb)) (step ST906). Also, radio status adjustment section 603 adjusts the reception field strength to be output by means of selected adjustment value AD2(Rb). For example, radio status adjustment section 603 multiplies reception field strength detection result Rb input from first reception field strength detection section 101 by “adjustment value AD2(Rb)=0.9”, finds adjustment result Ra by comparing the multiplication result with a threshold value, and outputs found adjustment result Ra. Then display section 105 displays adjustment result Ra.

On the other hand, if reception field strength detection result Rc input from second reception field strength detection section 102 is not greater than or equal to adjustment value calculation table threshold value rcr2 (step ST905: No), radio status adjustment section 603 refers to the adjustment value calculation table held in adjustment value calculation table holding section 602, and selects adjustment value AD3(Rb) as adjustment result Ra (Ra=AD3(Rb)) (step ST907). Also, radio status adjustment section 603 adjusts the reception field strength to be output by means of selected adjustment value AD3(Rb). For example, radio status adjustment section 603 multiplies reception field strength detection result Rb input from first reception field strength detection section 101 by “adjustment value AD3(Rb)=0.7”, finds adjustment result Ra by comparing the multiplication result with a threshold value, and outputs found adjustment result Ra. Then display section 105 displays adjustment result Ra.

In FIG. 9, processing in step ST901 and step ST902 is processing in accordance with the out of service determination table, and processing in step ST903 through step ST907 is processing in accordance with the adjustment value calculation table.

Thus, according to this embodiment, in addition to the provision of the effects of Embodiment 1 described above, processing for determining reception field strength can be simplified since reception field strength to be displayed is determined using a threshold value held in a table. Also, according to this embodiment, a plurality of threshold values are provided for comparison with reception field strength detection result Rc input from the second reception field strength detection section, enabling reception field strength to be switched in a step-by-step manner, and enabling user caution to be prompted in a step-by-step manner.

### Embodiment 3

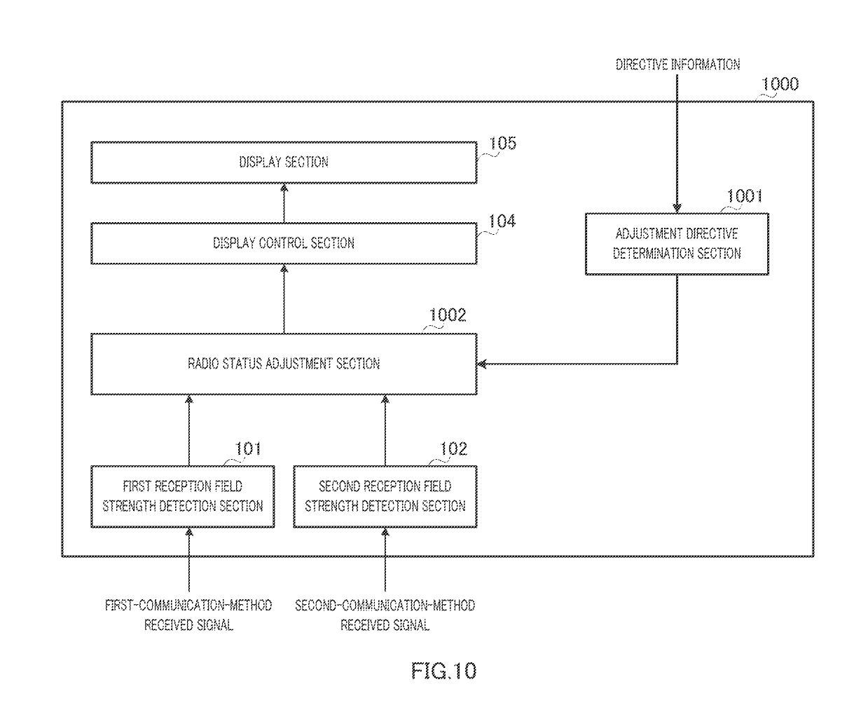

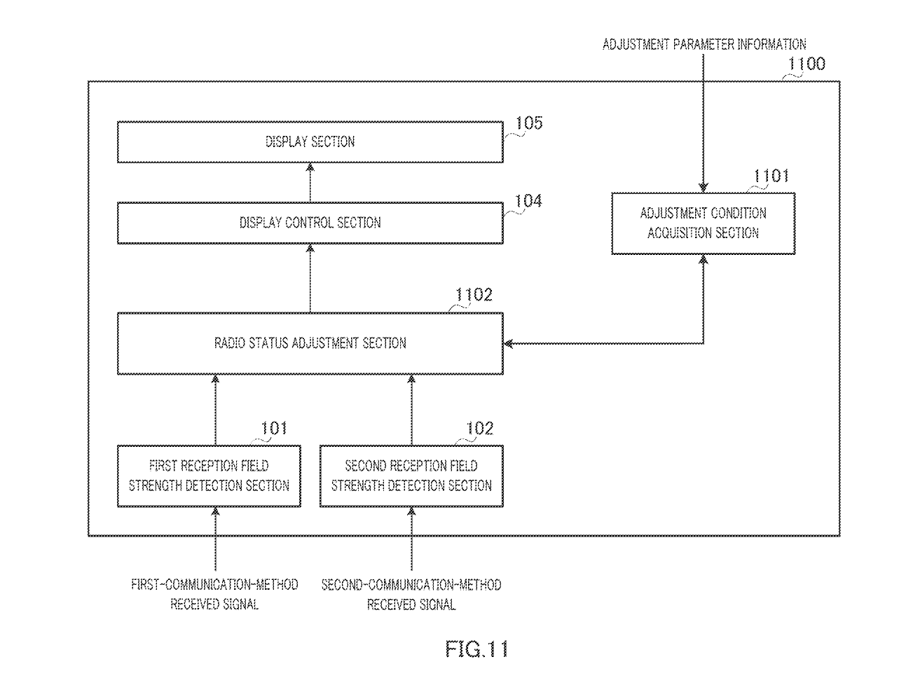

FIG. 10 is a block diagram showing the configuration of radio terminal apparatus 1000 according to Embodiment 3 of the present invention.

As compared with radio terminal apparatus 100 according to Embodiment 1 shown in FIG. 1, radio terminal apparatus 1000 shown in FIG. 10 is additionally provided with adjustment command determination section 1001, and has radio status adjustment section 1002 instead of radio status adjustment section 103. Configuration parts in FIG. 10 identical to those in FIG. 1 are assigned the same reference codes as in FIG. 1, and descriptions thereof are omitted here.

When adjustment command determination section 1001 acquires command information commanding reception field strength adjustment, adjustment command determination section 1001 commands radio status adjustment section 1002 to adjust reception field strength. Here, command information is, for example, information indicating that a service provided by means of communication using both a first communication method and a second communication method has been selected by the user by depression of a service selection button (not shown) provided on radio terminal apparatus 1000, information indicating that the URL of a service provider associated by means of a URL has been selected, information indicating that a service is a service provided by means of communication using both a first communication method and a second communication method held in data received by means of the first communication method or second communication method, or that a service is a service provided by means of communication using both a first communication method and a second communication method held in data further received by means of the first communication method and second communication method by selecting information (for example, a URL) held in data received by means of the first communication method or second communication method.

First reception field strength detection section 101 has a first-communication-method received signal received by an antenna (not shown) as input, and detects the reception field strength of the input first-communication-method received signal. Then first reception field strength detection section 101 outputs the detected reception field strength to radio status adjustment section 1002 as a detection result, or outputs a number of antenna bars corresponding to the detected reception field strength to radio status adjustment section 1002 as a detection result.

Second reception field strength detection section 102 has a second-communication-method received signal received by an antenna (not shown) as input, and detects the reception field strength of the input second-communication-method received signal. Then second reception field strength detection section 102 outputs the detected reception field strength to radio status adjustment section 1002 as a detection result, or outputs a number of antenna bars corresponding to the detected reception field strength to radio status adjustment section 1002 as a detection result.

If performance of reception field strength adjustment has been commanded by adjustment command determination section 1001, radio status adjustment section 1002 determines the reception field strength when service is received using both the first communication method and the second communication method based on the reception field strength detection result input from first reception field strength detection section 101 and the reception field strength detection result input from second reception field strength detection section 102. At this time, radio status adjustment section 1002 determines the number of bars in an antenna bar display on display section 105 as the reception field strength. Then radio status adjustment section 1002 outputs the determined reception field strength to display control section 104. Provision may also be made for radio status adjustment section 1002 to output the reception field strength determined this time to display control section 104 only if the reception field strength determined this time is different from the reception field strength determined the previous time.

Display control section 104 performs display processing for displaying the reception field strength input from radio status adjustment section 1002, and performs control to display the reception field strength on display section 105.

Except for the fact that reception field strength adjustment is performed when commanded by adjustment command determination section 1001, the operation of radio terminal apparatus 1000 is as shown in FIG. 2 through FIG. 5, and therefore a description thereof is omitted here.

Thus, according to this embodiment, in addition to the provision of the effects of Embodiment 1 described above, reception field strength adjustment is performed only when necessary, enabling the processing load associated with reception field strength adjustment to be alleviated. Also, according to this embodiment, switching between performing or not performing reception field strength adjustment can be performed for each service provided to a user based on command information, enabling reception field strength display appropriate to a type of service to be performed.

### Embodiment 4

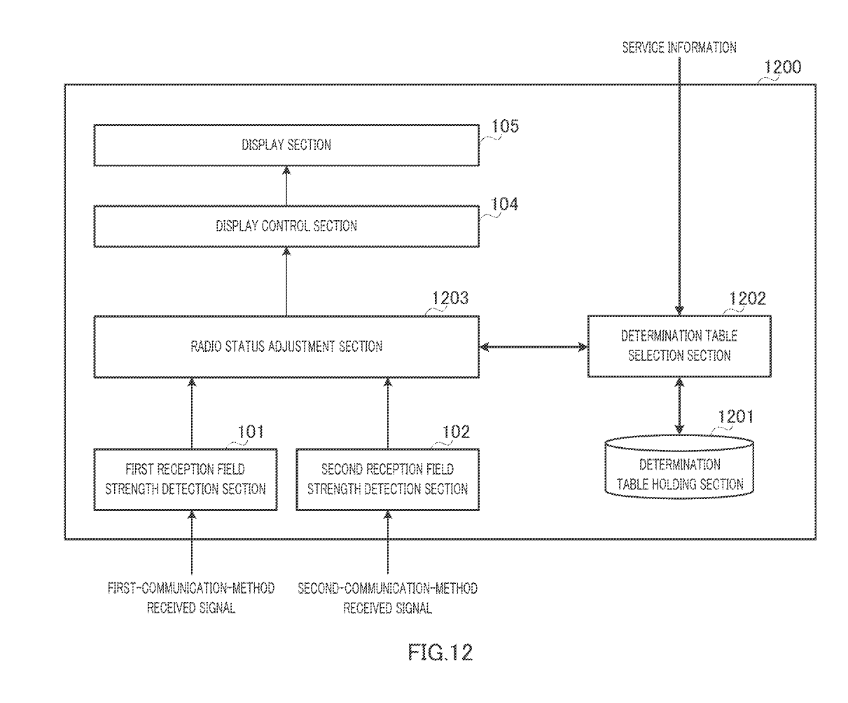

FIG. 11 is a block diagram showing the configuration of radio terminal apparatus 1100 according to Embodiment 4 of the present invention.

As compared with radio terminal apparatus 100 according to Embodiment 1 shown in FIG. 1, radio terminal apparatus 1100 shown in FIG. 11 is additionally provided with adjustment condition acquisition section 1101, and has radio status adjustment section 1102 instead of radio status adjustment section 103. Configuration parts in FIG. 11 identical to those in FIG. 1 are assigned the same reference codes as in FIG. 1, and descriptions thereof are omitted here.

Adjustment condition acquisition section 1101 acquires adjustment parameter information. Here, adjustment parameters are, for example, threshold values #501 through #506 in FIG. 5, or information in the tables in FIG. 7 and FIG. 8.

First reception field strength detection section 101 has a first-communication-method received signal received by an antenna (not shown) as input, and detects the reception field strength of the input first-communication-method received signal. Then first reception field strength detection section 101 outputs the detected reception field strength to radio status adjustment section 1102 as a detection result, or outputs a number of antenna bars corresponding to the detected reception field strength to radio status adjustment section 1102 as a detection result.

Second reception field strength detection section 102 has a second-communication-method received signal received by an antenna (not shown) as input, and detects the reception field strength of the input second-communication-method received signal. Then second reception field strength detection section 102 outputs the detected reception field strength to radio status adjustment section 1102 as a detection result, or outputs a number of antenna bars corresponding to the detected reception field strength to radio status adjustment section 1102 as a detection result.

Radio status adjustment section 1102 determines the reception field strength when service is received using both the first communication method and the second communication method by comparing the reception field strength detection result input from first reception field strength detection section 101 and the reception field strength detection result input from second reception field strength detection section 102 with a threshold value acquired by adjustment condition acquisition section 1101. At this time, radio status adjustment section 1102 determines the number of bars in an antenna bar display on display section 105 as the reception field strength. Then radio status adjustment section 1102 outputs the determined reception field strength to display control section 104. Provision may also be made for radio status adjustment section 1102 to output the reception field strength determined this time to display control section 104 only if the reception field strength determined this time is different from the reception field strength determined the previous time.

Display control section 104 performs display processing for displaying the reception field strength input from radio status adjustment section 1102, and performs control to display the reception field strength on display section 105.

Except for the fact that a threshold value is set using adjustment parameter information acquired by adjustment condition acquisition section 1101, the operation of radio terminal apparatus 1100 is as shown in FIG. 2 through FIG. 5, and therefore a description thereof is omitted here.

Thus, according to this embodiment, in addition to the provision of the effects of Embodiment 1 described above, it is not necessary to store a threshold value, enabling storage capacity to be reduced and the apparatus to be made smaller. Also, according to this embodiment, a different threshold value can be set when service contents are changed or when a change occurs in the time period, the communication environment, or suchlike environmental conditions, enabling reception field strength appropriate to service contents and environmental conditions to be displayed.

In this embodiment, parameter information comprises threshold values #501 through #506 in FIG. 5, or information in the tables in FIG. 7 and FIG. 8, but the present invention is not limited to this, and may also use parameter information for finding threshold values #501 through #506 in FIG. 5, or threshold values in the tables in FIG. 7 and FIG. 8, by means of calculation.

### Embodiment 5

FIG. 12 is a block diagram showing the configuration of radio terminal apparatus 1200 according to Embodiment 5 of the present invention.

As compared with radio terminal apparatus 100 according to Embodiment 1 shown in FIG. 1, radio terminal apparatus 1200 shown in FIG. 12 is additionally provided with determination table holding section 1201 and determination table selection section 1202, and has radio status adjustment section 1203 instead of radio status adjustment section 103. Configuration parts in FIG. 12 identical to those in FIG. 1 are assigned the same reference codes as in FIG. 1, and descriptions thereof are omitted here.

Determination table holding section 1201 holds a reception field strength adjustment table for each service.

Determination table selection section 1202 acquires service information that is information relating to a service, and selects a determination table corresponding to the service to which the acquired service information relates from the determination tables stored in determination table holding section 1201. Here, service information is information on transmitted data transmission capacity, transmitted data type, such as voice, image, and so forth, type of service contents, or the like.

First reception field strength detection section 101 has a first-communication-method received signal received by an antenna (not shown) as input, and detects the reception field strength of the input first-communication-method received signal. Then first reception field strength detection section 101 outputs the detected reception field strength to radio status adjustment section 1203 as a detection result, or outputs a number of antenna bars corresponding to the detected reception field strength to radio status adjustment section 1203 as a detection result.

Second reception field strength detection section 102 has a second-communication-method received signal received by an antenna (not shown) as input, and detects the reception field strength of the input second-communication-method received signal. Then second reception field strength detection section 102 outputs the detected reception field strength to radio status adjustment section 1203 as a detection result, or outputs a number of antenna bars corresponding to the detected reception field strength to radio status adjustment section 1203 as a detection result.

Radio status adjustment section 1203 determines the reception field strength when service is received using both the first communication method and the second communication method by comparing the reception field strength detection result input from first reception field strength detection section 101 and the reception field strength detection result input from second reception field strength detection section 102 with respective threshold values held in the determination table selected by determination table selection section 1202. At this time, radio status adjustment section 1203 determines the number of bars in an antenna bar display on display section 105 as the reception field strength. Then radio status adjustment section 1203 outputs the determined reception field strength to display control section 104. Provision may also be made for radio status adjustment section 1203 to output the reception field strength determined this time to display control section 104 only if the reception field strength determined this time is different from the reception field strength determined the previous time.

Display control section 104 performs display processing for displaying the reception field strength input from radio status adjustment section 1203, and performs control to display the reception field strength on display section 105.

Except for the fact that a determination table is selected using service information and reception field strength is adjusted based on the selected determination table, the operation of radio terminal apparatus 1200 is as shown in FIG. 2 through FIG. 5, and therefore a description thereof is omitted here.

Thus, according to this embodiment, in addition to the provision of the effects of Embodiment 1 described above, reception field strength appropriate to service contents can be displayed by enabling a different threshold value to be set according to service contents.

In above Embodiment 1 through Embodiment 5, a radio status adjustment section adjusts the number of bars in an antenna bar display on a display section, but the present invention is not limited to this, and any display that indicates reception field strength may be adjusted. Also, in above Embodiment 1 through Embodiment 5, service provision is received using two communication methods—a first communication method and a second communication method—but the present invention is not limited to this, and may also be applied to a case in which service provision is received using any three or more communication methods. Furthermore, in above Embodiment 1 through Embodiment 5, a case has been described in which communication quality is reception field strength, but the present invention is not limited to this, and quality may also be based on a measure such as the transmission or reception data error rate, packet loss rate, transmission delay amount, data transmission speed, field strength variation, or the like.

The disclosure of Japanese Patent Application No. 2008-265320, filed on Oct. 14, 2008, including the specification, drawings and abstract, is incorporated herein by reference in its entirety.

### INDUSTRIAL APPLICABILITY

A radio terminal apparatus and communication quality display method according to the present invention are particularly suitable for receiving service provision using a plurality of different communication methods.

1. A radio terminal apparatus comprising:
a detection section that, when service provision is received by performing communication by means of a plurality of different communication methods, detects communication quality individually when communication is performed by each communication method;
a determination section that determines communication quality when the service provision is received, based on each detected communication quality; and
a display section that displays the determined communication quality.

2. The radio terminal apparatus according to claim 1, wherein the determination section determines communication quality when the service provision is received, by adjusting communication quality of the communication method for which a volume of data to transmit is largest.

3. The radio terminal apparatus according to claim 1, wherein:
the detection section detects first communication quality when communication is performed by means of a first communication method and second communication quality when communication is performed by means of a second communication method; and
the determination section, if the second communication quality is less than or equal to a threshold value, determines communication quality resulting from decreasing the first communication quality by a predetermined amount to be communication quality when the service provision is received.

4. The radio terminal apparatus according to claim 1, wherein:
the detection section detects first communication quality when communication is performed by means of a first communication method and second communication quality when communication is performed by means of a second communication method; and
the determination section calculates a weighted average of the first communication quality and the second communication quality, and if the calculated weighted average is less than or equal to a threshold value, determines communication quality resulting from decreasing the first communication quality by a predetermined amount to be communication quality when the service provision is received.

5. The radio terminal apparatus according to claim 1, wherein:
the display section displays communication quality determined by the determination section by means of an antenna bar display; and
the determination section determines a number of bars in displayed the antenna bar display.

6. The radio terminal apparatus according to claim 1, wherein the determination section, if at least one of communication qualities detected by the detection section is at an out of service level, displays communication quality when the service provision is received as out of service on the display section.

7. The radio terminal apparatus according to claim 1, wherein:
the detection section detects first communication quality when communication is performed by means of a first communication method and second communication quality when communication is performed by means of a second communication method; and
the determination section has a table in which a communication quality and an adjustment value are associated, and selects the adjustment value by referring to the table using the second communication quality, and determines communication quality when the service provision is received by adjusting the first communication quality by means of the selected adjustment value.

8. The radio terminal apparatus according to claim 1, further comprising a commanding section that commands the determination section to perform the determination when reception of the service provision is detected, wherein the detection section performs the determination when the command is received.

9. The radio terminal apparatus according to claim 1, further comprising an acquisition section that acquires parameter information that is threshold value information, wherein the determination section determines communication quality when the service provision is received by comparing a threshold value of the acquired parameter information with communication quality detected by the detection section.

10. The radio terminal apparatus according to claim 1, further comprising:
a holding section that holds a table for each service in which communication quality and a adjustment value are associated; and
a selection section that selects the table according to a service provision of which is received, wherein:
the detection section detects first communication quality when communication is performed by means of a first communication method and second communication quality when communication is performed by means of a second communication method; and
the determination section selects the adjustment value by referring to the table selected by the selection section, using the second communication quality, and determines communication quality when the service provision is received by adjusting the first communication quality by means of the selected adjustment value.

11. A communication quality display method that is a communication quality display method in a radio terminal apparatus that receives service provision by performing communication by means of a plurality of different communication methods, the communication quality display method comprising the steps of:
detecting communication quality individually when communication is performed by each communication method;
determining communication quality when the service provision is received, based on each detected communication quality; and
displaying the determined communication quality.
